(19) United States
(12) Patent Application Publication
(10) Pub. No.: US 2005/0228319 A1
(43) Pub. Date: Oct. 13, 2005

(54) Neoplasm cell destruction device

(76) Inventor: Daniele J. Kenny, East Setauket, NY (US)

Correspondence Address: Bernard S. Hoffman, Suite 7F, 460 Old Town Road, Port Jefferson Station, NY, 11776, US

(21) Appl. No.: 11/134,011

(22) Filed: May 20, 2005

Related U.S. Application Data
(63) Continuation of application No. 08/777,452, filed on Dec. 30, 1996.

(51) Int. Cl. A61H 1/00

(52) U.S. Cl. 601/2

(57) ABSTRACT

A neoplasm cell destruction device. The device includes at least one signal generator and at least one transducer. The at least one transducer is driven by the at least one signal generator, and produces sound waves. The sound waves are impacted upon a neoplastic target to damage, and ultimately destruct, the neoplastic target.

### CROSS REFERENCE TO RELATED APPLICATIONS

The instant application is a Continuation application of application Ser. No. 08/777,452 filed by Daniele J. Kenny on Dec. 30, 1996 for a NEOPLASM CELL DESTRUCTION DEVICE UTILIZING LOW FREQUENCY SOUND WAVES TO DISRUPT OR DESTROY NEOPLASTIC CELLULAR MATERIALS, which contains subject matter of a Disclosure Document previously submitted.

### BACKGROUND OF THE INVENTION

1. Field of the Invention

The present invention relates to a cell destruction device, and more particularly, the present invention relates to a neoplasm cell destruction device.

2. Description of the Prior Art

Ultrasound may be used to remotely heat industrial or biological materials. There has been strong evidence in research and clinical laboratories that focused ultrasound for cancer hyperthermia will become a useful mode of treating cancer patients, in addition to the surgical, radiological, and chemotherapeutic methods available now.

In the treatment of tumors in cancer hyperthermia, focused ultrasound heats the tumor to a temperature of approximately 43° C., while the adjacent healthy tissue is kept at a lower temperature, closer to normal body temperature (37° C.). The elevated temperature in the tumor disrupts the tumor growth and eventually kills it. This allows the cancer to potentially be treated without surgery, without ionizing radiation, or without chemotherapy.

Conventional focused ultrasound for heating is employed by using either a scanned ultrasound transducer or a phased array. The scanned transducer uses a lens, much like an optical magnifying glass focus sunlight, while the phased array uses electronic delays among the array elements to achieve focusing. A burst of ultrasound is then emitted converging at the focus to provide localized high intensity energy. Some of the high energy is absorbed by the tissue at the focus and is dissipated as concentrated focal heat. The rest of the energy travels through the focus and is slowly dissipated into the surrounding tissues as distributed heat.

Biomedical hyperthermia applicators using a plurality of ultrasound sources to heat larger, distributed volumes, have also been investigated. These investigations have relied upon linear thermal superposition of the plurality of ultrasound sources to heat the target tissue. Nonlinear effects of ultrasound propagation through animal tissue and materials have also been studied for a single ultrasound source.

It is generally recognized that the use of microwave energy to produce moderate internal heating is also an effective tool in the treatment of tissue, especially neoplastic tumors. The primary factor limiting such treatment in the past has been the difficulty of delivering the heat to a target region below the skin surface without causing cavitation and/or heating of healthy soft tissues.

In order to achieve significant heating in tumors more than a few millimeters below the skin surface, the field from a single source at the skin surface will have to be high and therefore painful. See U.S. Pat. No. 5,503,150 to Evans at col. 1, lines 26-29.

One approach has used a moving source, generally activated by switching discrete sub-arrays of sources. The moving ultrasound source, however, results in an incoherent summation of energy at the tumor site. While tending to reduce the heating effects in the intervening tissue, this method has not eliminated the heating of the intervening tissue or reduced it to an acceptable level.

Additionally with ultrasound therapy, to insure that the desired volume of tissue is potentially heated, an operator must not only know the characteristics in the area of interest, but also be able to determine which tissues are being heated. Currently, the ability to make this determination depends on the use of an interstitial probe or a radiometer. The current method also does not allow for imaging of the area, except to use other modalities, such as CT.

Further, it has been found that cancer cells are rapidly killed by mechanical trauma associated with shape-transitions causing increases in cell surface area. The hypothesis has been advanced that these increases in surface area occur in two phases. First, there is an apparent increase as a result of surface unfolding, which is reversible and therefore non-lethal. Second, there is a true increase during which cell surface membranes are stretched, with an increase in membrane tension. When tension exceeds a critical level, the surface membranes rupture and the irreversible change is lethal to the cell. See L. Weiss, J. P. Harlos, and G. Elkin; Int. J. Cancer 44; 143-148 (1989).

Numerous other innovations for wave treatments have been provided in the prior art that will be described infra. Even though these other innovations may be suitable for the specific individual purposes to which they address, however, they differ from the present invention.

For example, U.S. Pat. No. 3,880,152 issued to Nohmura on Apr. 29, 1975 teaches a chair or a bed with speakers incorporated therein. The speakers are disposed against the inside surfaces of the seat and back of the chair, and the top surface of the bed, so that the openings of the speakers will be directed toward a human body resting therein.

Another example, U.S. Pat. No. 4,055,170 issued to Nohmura on Oct. 25, 1977 teaches a health promoting apparatus including a chair, bed, or the like with a loudspeaker incorporated therein. An opening formed in the chair is closed by a pretensioned flexible sheet. The sound waves from the loudspeaker cause the flexible sheet to vibrate thereby transmitting vibrations to a chair occupant.

Still another example, U.S. Pat. No. 4,315,514 issued to Drewes et al. on Feb. 16, 1982 teaches an ultrasound apparatus and a method for destroying selected cells in a host without damage to non-selected cells including selecting a transmission path from an energy source to the selected cells, determining one or more of the resonant frequencies of the selected cells, selecting as a destructive frequency one of the resonant frequencies at which the transmissibility of the selected cells is higher than the transmissibility of the non-selected cells in the transmission path, and transmitting energy from the source at the destructive frequency along the path with sufficient intensity to destroy the selected cells without destroying the non-selected cells.

Yet another example, U.S. Pat. No. 4,674,505 issued to Pauli et al. teaches an essentially planar shock wave generated with the assistance of a shock wave tube via a magnetic dynamic effect. The shock wave is focused by an acoustic convergent lens, whereby the calculus to be pulverized is placed at the focal point of the convergent lens. In order to couple the shock wave to the patient, the space that the shock wave traverses is filled with a coupling agent, for example water. The shock wave tube, the convergent lens, and a fine adjustment for the displacement of the convergent lens relative to the shock wave tube are attached to a mounting stand so as to be pivotable in all directions. The disintegration facility includes a shock wave tube having high operating reliability with respect to high voltage, requires low maintenance, and has only negligible imaging or focusing errors resulting from the shock wave producing membrane and the convergent lens.

Still yet another example, U.S. Pat. No. 4,753,225 issued to Vogel on Jun. 28, 1988 teaches therapy equipment for the human body serving to enhance the feeling of good health by exposure of a part of or all of the body to acoustic irradiation with frequencies in the sub-audio, audio, and ultrasonic regions. The therapy equipment includes at least one oscillator plate arranged in bodily contact with the body of the person who sits, lies, or stands on it. The oscillator plate is made to oscillate by sound waves, whereby corresponding oscillation generators are secured in bodily contact to the oscillator plate. The frequency of the sound waves is adjusted to the reabsorption frequency of individually selected organs and parts of the body to treat selective individual organs or parts of the human body.

Yet still another example, U.S. Pat. No. 5,062,412 issued to Okazaki on Nov. 5, 1991 teaches electrically and simultaneously forming a plurality of focused regions of shock waves. A shock wave generating apparatus includes a plurality of high-voltage pulse generators for generating a plurality of high-voltage pulses, a shock wave generating unit having a plurality of ultrasonic vibrating element groups coupled to the plurality of high voltage pulse generators for generating shock waves and for focusing the shock waves onto a plurality of different focused regions within a biological body under examination, and a plurality of delay units coupled via the high-voltage pulse generators to the plural ultrasonic vibrating element groups for causing the plurality of high-voltage pulses having predetermined delay times to be generated from the high-voltage pulse generators whereby the plural focused regions are simultaneously formed juxtaposed each other near a concretion to be disintegrated with the biological body.

Still yet another example, U.S. Pat. No. 5,086,755 issued to Schmid-Eilber on Feb. 11, 1992 teaches a chaise lounge for therapeutic treatment of a patient including three support sections hinged together so as to be pivotable relative to one another for comfortably supporting a patient. The support sections have openings formed therein spaced along the longitudinal centerline of the chaise lounge and electroacoustic transducers movably disposed below the openings and adapted to radiate upwardly through the openings at the lower back, the chest, and the head/neck areas of a patient resting on the chaise longue with an enhanced signal of a frequency corresponding to the rhythm frequency of certain music to which the patient's body is exposed. The rhythm frequency is in the non-audible range and adapted to achieve total relaxation of the patient.

Yet still another example, U.S. Pat. No. 5,095,890 issued to Houghton et al. on Mar. 17, 1992 teaches a method for automatically optimizing ultrasonic frequency power applied by a transducer to human tissue while the transducer is energized with ultrasonic signals from an ultrasonic signal generator. The frequency of an ultrasonic energizing signal applied by the ultrasonic signal generator to the transducer is set. The frequency of the energizing signal applied to the ultrasonic signal generator to the transducer is scanned at reoccurring intervals through a sequence of frequencies. The optimum level of power from the transducer is monitored as the frequency is scanned. The frequency of the ultrasonic energizing signal applied by the ultrasonic signal generator is ultimately reset substantially at the frequency causing the optimum level of power until the next reoccurring interval.

Still yet another example, U.S. Pat. No. 5,143,063 issued to Fellner on Sep. 1, 1992 teaches an electromedical apparatus employed to non-invasively remove adipose tissue from the body by causing necrosis thereof by localizing, e.g. focusing, radiant energy. The radiant energy may be of any suitable kind, for example, localized radio frequency, microwave, or ultrasound energy that is impinged upon the cells to be eliminated. Cell destruction occurs through a mechanism such as, e.g., heating or mechanical disruption beyond a level that the adipose tissue can survive.

Yet still another example, U.S. Pat. No. 5,144,953 issued to Wurster et al. on Sep. 8, 1992 teaches a lithotriptor with an X-ray alignment system including a transducer for generating focused ultrasonic shock waves adapted for alignment on a concretion or tissue to be destroyed. The transducer is connected to an image-forming diagnostic X-ray system for locating the concretion or tissue and includes an X-ray emitter and an image intensifier disposed on a pivotable frame. The transducer is connected to the X-ray emitter that in turn is disposed at the center of the transducer so that the emission axes of the transducer and the X-ray emitter coincide.

Still yet another example, U.S. Pat. No. 5,178,134 issued to Vago on Jan. 12, 1993 teaches ultrasonic treatment of animals. The equipment is able to apply ultrasonic waves with at least two power densities in the vicinity of the portion of the animal, with one of the power densities being more than 15 watts per square meter for sterilizing the water before the patient enters the tube and the other being less than 15 watts per square meter.

Yet still another example, U.S. Pat. No. 5,209,221 issued to Riedlinger on May 11, 1993 teaches a device for generating sonic signal forms for limiting, preventing, or regressing the growth of pathological tissue including an ultrasonic transmission system for transmitting sound waves focused on the tissue to be treated by way of a coupling medium. An ultrasonic signal produced at the focus of the system includes brief pulses having at least one rarefaction phase with a negative sonic pressure amplitude with a value greater than 2×10⁵ Pa. The ultrasonic signal is radiated with a carrier frequency exceeding 20 kHz, a sonic pulse duration T of less than 100 μs and a pulse recurrence rate of less than 1/(5 T). The device produces controlled cavitation in the tissue to be treated.

Still yet another example, U.S. Pat. No. 5,222,484 issued to Krauss et al. on Jun. 29, 1993 teaches an apparatus for shock wave treatment including a shock wave transducer with a cup-shaped body and with an X-ray location finding device for finding the location of a bodily concretion or tissue to be treated. The X-ray device includes an extendable X-ray tube with telescoping tube sections sealed against an acoustic coupling medium filling the delay path of the transducer by a balloon filling arranged within the X-ray tube. The balloon is secured to the upper section of the tube and to the lower section thereof. Over pressure or under pressure is applied to the interior of the X-ray tube to adjust its length in order to optimize X-ray location finding on the one hand and shock wave treatment on the other hand.

Yet still another example, U.S. Pat. No. 5,388,581 issued to Bauer et al. on Feb. 14, 1995 teaches a therapy apparatus for treating concretions and tissue in the body of a patient by way of sound waves. The apparatus includes a sound wave generator and an available X-ray device for locating an object for therapy. The therapy apparatus has a spot film device arranged within the axial passage of an X-ray cone. The available X-ray device is attached to the sound wave generator, with its central longitudinal axis aligned with the focus thereof so as to be able to precisely adjust and fix the X-ray device to the therapy apparatus quickly and safely.

Still yet another example, U.S. Pat. No. 5,435,311 issued to Umemura et al. on Jul. 25, 1995 teaches an ultrasound therapeutic system provided with an ultrasound transmitter having a focusing mechanism and a plurality of groups of ultrasound transmitters/receivers, each of which has a controllable directivity, each of the transmitters/receivers is constructed so as to be able to receive both echo of pulse-shaped ultrasound transmitted by itself and even order harmonic signals of the ultrasound transmitted by the transmitter, and a plurality of two-dimensional pulse echographical images constructed by ultrasound signals obtained by transmitting/receiving beams, while controlling the directivity of the beam emitted by each of the plurality of groups of ultrasound transmitters/receivers and a plurality of images indicating orientation and intensity, in which an even order harmonic wave signal due to the ultrasound transmitted by the transmitter is received by each of the plurality of groups of ultrasound transmitters/receivers, are displayed, superimposed on each other.

Yet still another example, U.S. Pat. No. 5,498,236 issued to Dubrul et al. on Mar. 12, 1996 teaches a catheter suitable for introduction into a tubular tissue for dissolving blockages in such tissue. The catheter is particularly useful for removing thrombi within blood vessels. In accordance with the preferred embodiments, a combination of vibrating motion and injection of a lysing agent is utilized to break up blockages in vessels. The vessels may be veins, arteries, ducts, intestines, or any lumen within the body that may become blocked from the material flowing through it. As a particular example, dissolution of vascular thrombi is facilitated by advancing a catheter through the occluded vessel with the catheter causing a vibrating stirring action in and around the thrombus, usually in combination with the dispensing of a thrombotic agent, such as urokinase into the thrombus. The catheter has an inflatable or expandable member near the distal tip that when inflated or expanded prevents the passage of dislodged thrombus around the catheter. The dislodged portions of the thrombus are directed through a perfusion channel in the catheter where they are removed by filtration apparatus housed within the perfusion channel before the blood exits the tip of the catheter. Catheters allowing both low frequency (1-1000 Hz) vibratory motion and delivery of such agents to a blockage and a method for using such catheters are disclosed.

Still yet another example, U.S. Pat. No. 5,501,655 issued to Rolt et al. on Mar. 26, 1996 teaches an ultrasound hyperthermia applicator suitable for medical hyperthermia treatment and a method for using it. The applicator includes two ultrasound sources producing focused ultrasound beams of frequencies f₀ and f₁. An aiming device directs the two ultrasound beams so that they cross each other confocally at the target. A controller activates the two ultrasound sources so that the target is simultaneously irradiated by the two focused ultrasound beams. The two ultrasound sources provide acoustic energy sufficient to cause sufficient intermodulation products to be produced at the target as a result of the interaction of the two ultrasound beams. The intermodulation products are absorbed by the target to enhance heating of the target. In preferred embodiments, the ultrasound sources include a pair of signal generators for producing gated ultrasound output signals driving single crystal ultrasound transducers. In other embodiments, the ultrasound sources include a pair of phased array ultrasound transducers for generating two separate ultrasound beams. An aiming device is provided for electronically steering and focusing the two ultrasound beams so that they cross each other confocally at the target. Further embodiments employ pluralities of transducers, arrays, or both.

Yet still another example, U.S. Pat. No. 5,503,150 issued to Evans on Apr. 2, 1996 teaches a method and apparatus for noninvasively locating and heating a volume of tissue, specifically a cancerous tumor. The method includes placing a bolus in contact with the patient and substantially around an area of interest including the volume of tissue, placing an array of antennas on the bolus and substantially around the area of interest, imaging the area of interest, selecting an approximate center of the volume of tissue on the initial image, determining approximate amplitudes and phases for the antennas, energizing each element at respective appropriate amplitudes and phases to heat the volume of tissue, imaging respectively the area of interest to create subsequent images, and subtracting the initial image from the subsequent images to determine temperature changes in the area of interest.

Still yet another example, U.S. Pat. No. 5,524,625 issued to Okazaki et al. on Jun. 11, 1996 teaches a shock wave generating system capable of forming a wide concretion-disintegrating region by energizing ring-shaped transducers and a hyperthermia curing system. A width of a focused region synthesized from a plurality of focal points formed by a plurality of shock waves is varied by properly controlling delay times and/or drive voltages for a plurality of ring-shaped piezoelectric transducer elements. The shock wave generating system includes a shock wave generating unit having a plurality of shock wave generating elements and a driving unit for separately driving the plurality of shock wave generating elements by controlling at least delay times to produce a plurality of shock waves in a manner that a dimension of a focused region synthesized from a plurality of different focal points formed by the plurality of shock waves is varied in accordance with a dimension of a concretion to be disintegrated present in a biological body under medical examination.

Yet still another example, U.S. Pat. No. 5,529,572 issued to Spector on Jun. 25, 1996 teaches a method and apparatus for increasing the density and strength of bone, particularly for preventing or treating osteoporosis, by subjecting the bone to unfocussed compressional shock waves.

Still yet another example, U.S. Pat. No. 5,542,906 issued to Herrmann et al. on Aug. 6, 1996 teaches a therapy apparatus having a source of acoustic waves generating acoustic waves focused onto a focus and an X-ray locating apparatus with which the subject to be treated can be irradiated from different directions. The central ray of the locating apparatus assumes a first direction for a first irradiation direction and a second direction for a second irradiation direction. The apparatus has a positioning system with which the subject to be treated and the focus can be adjusted relative to one another. The region to be treated and the focus are adjustable relative to one another by synchronous actuation of the positioning system in two adjustment directions for at least one irradiation direction. The adjustment taking place in a direction proceeding parallel to the direction of the central ray belonging to the other irradiation direction.

Yet still another example, U.S. Pat. No. 5,549,544 issued to Young et al. on Aug. 27, 1996 teaches apparatus including a piezoelectric vibrator adapted to generate ultrasonic energy transmitted through an output section to a plastics head. The shape of the head may be varied to suit whichever part of a body on which it is to be used. The material and shape of the head is chosen to allow accurate control of frequency and amplitude of the ultrasonic energy.

Still yet another example, U.S. Pat. No. 5,558,623 issued to Cody on Sep. 24, 1996 teaches a therapeutic ultrasonic device transmitting multiple ultrasonic frequencies through one ultrasonic applicator. The applicator includes a handle, two diaphragms connected to one end of the handle with each diaphragm having an application face directed away from the handle and a rear face directed into the handle so that the application faces may be independently applied to a patient during therapy, and at least two piezoelectric crystals. A piezoelectric crystal is connected to the rear face of each diaphragm for converting periodic electrical energy into ultrasonic energy and transmitting the ultrasonic energy through the diaphragm to which the crystal is connected independently of the other diaphragm. An excitation source is provided for independently applying a periodic electric field of selectable frequency across a crystal in order to select the crystal to receive the periodic electric field and to select the ultrasonic frequency transmitted through the diaphragm to which the selected crystal is connected.

Yet still another example, U.S. Pat. No. 5,713,848 issued to Dubrul et al. on Feb. 3, 1998 teaches a catheter suitable for introduction into a tubular tissue for dissolving blockages in such tissue. The catheter is particularly useful for removing thrombi within blood vessels. In accordance with the preferred embodiments, a combination of vibrating motion and injection of a lysing agent is utilized to break up blockage in vessels. The vessels may be veins, arteries, ducts, intestines, or any lumen within the body that may become blocked from the material flowing through it. As a particular example, dissolution of vascular thrombi is facilitated by advancing a catheter through the occluded vessel. The catheter causes a vibrating, stirring action in and around the thrombus usually in combination with the dispensing of a thrombolytic agent, such as urokinase into the thrombus. The catheter has an inflatable or expandable member near the distal tip that when inflated or expanded prevents the passage of dislodged thrombus around the catheter. The dislodged portions of the thrombus are directed through a profusion channel in the catheter where they are removed by filtration apparatus housed within the perfusion channel before the blood exits the tip of the catheter. Catheters allowing both low frequency (1-1000 Hz) vibratory motion and delivery of such agents to a blockage and a method for using such catheters are disclosed.

It is apparent that numerous other innovations for wave treatments have been provided in the prior art that are adapted to be used. Furthermore, even though these other innovations may be suitable for the specific individual purposes to which they address, however, they would not be suitable for the purposes of the present invention as heretofore described.

### SUMMARY OF THE INVENTION

Accordingly, an object of the present invention is to provide a neoplasm cell destruction device that avoids the disadvantages of the prior art.

Briefly stated, another object of the present invention is to provide a neoplasm cell destruction device. The device includes at least one signal generator and at least one transducer. The at least one transducer is driven by the at least one signal generator, and produces sound waves. The sound waves impact upon a neoplastic target to damage, and ultimately destruct, the neoplastic target.

The novel features considered characteristic of the present invention are set forth in the appended claims. The invention itself, however, both as to its construction and its method of operation, together with additional objects and advantages thereof will be best understood from the following description when read and understood in connection with the accompanying drawing.

### BRIEF DESCRIPTION OF THE DRAWING

The figures of the drawing are briefly described as follows:

FIGS. 1A-1B are a block diagram of the neoplasm cell destruction device of the present invention; and

FIGS. 2A-2G are a flow chart of the method of operation of the neoplasm cell destruction device of the present invention.

### DETAILED DESCRIPTION OF THE PREFERRED EMBODIMENT

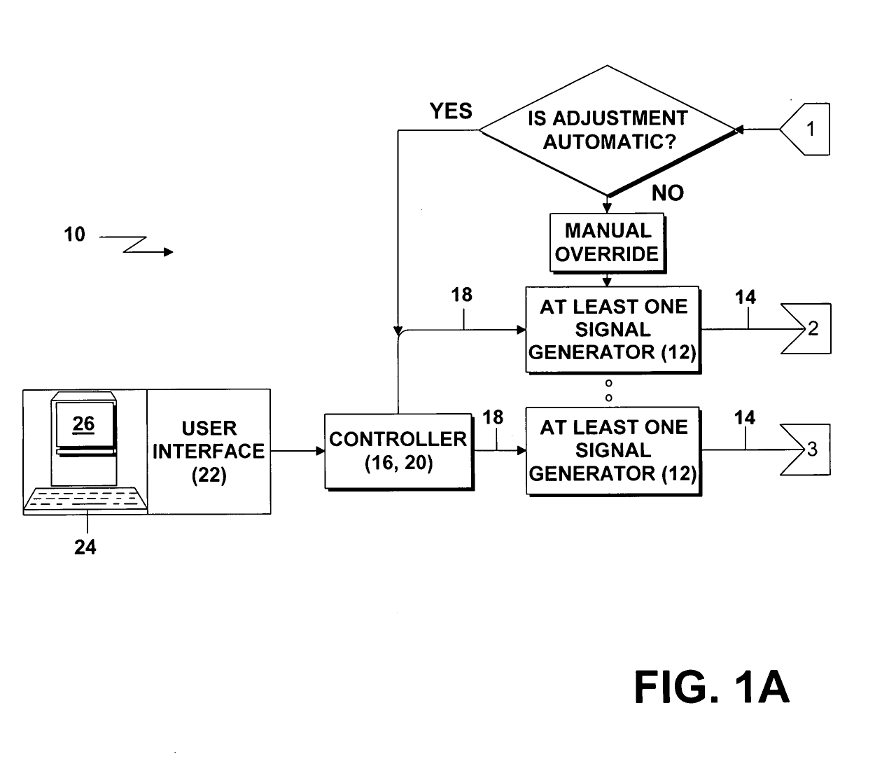

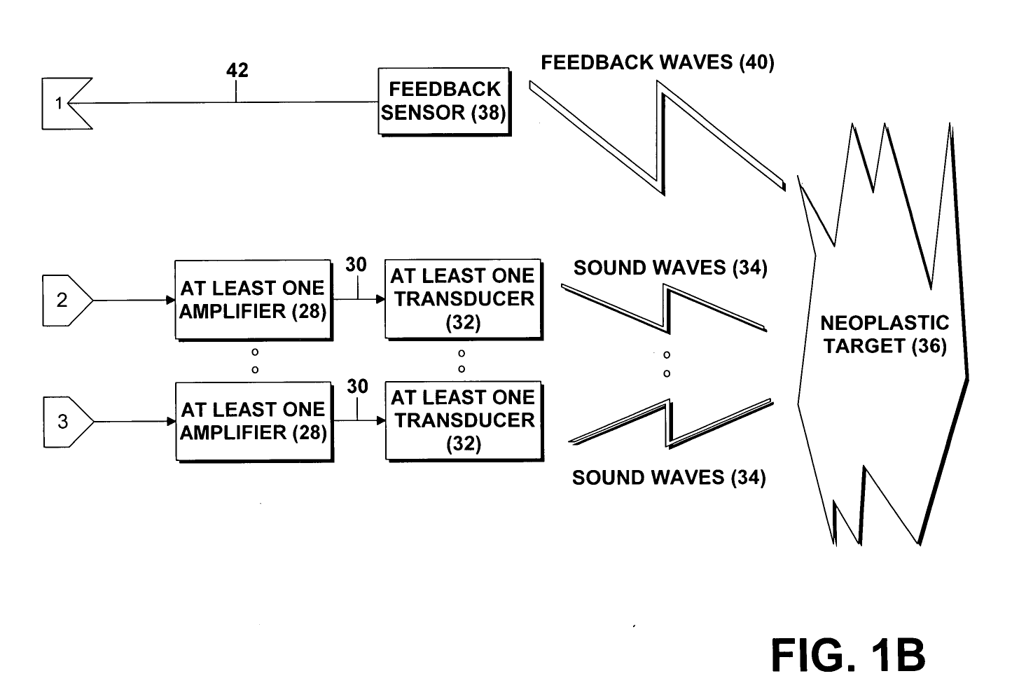

Referring now to the figures, in which like numerals indicate like parts, and particularly to FIGS. 1A to 1B, which is a block diagram of the neoplasm cell destruction device of the present invention, the neoplasm cell destruction device of the present invention is shown generally at 10.

The neoplasm cell destruction device 10 comprises at least one signal generator 12. The at least one signal generator 12 generates signals 14.

The neoplasm cell destruction device 10 further comprises a controller 16. The controller 16 is in communication with, and generates timing and control signals 18 to selectively activate, the at least one signal generator 12, and can be, inter alia, a microprocessor 20.

The neoplasm cell destruction device 10 further comprises a user interface 22. The user interface 22 is in communication with the controller 16, and can be, inter alia, a keyboard 24 and/or a display 26.

The neoplasm cell destruction device 10 further comprises at least one amplifier 28. The at least one amplifier 28 is in communication with the at least one signal generator 12, and amplifies the signals 14 generated thereby to produce amplified signals 30.

The neoplasm cell destruction 10 further comprises at least one transducer 32. The at least one transducer 32 is in communication with the at least one amplifier 28, and is driven by the amplified signals 30 to produce sound waves having frequencies in a range of 20 to 20,000 Hz. The sound waves 34—which due to lower energy than prior treatment sources reduces lethality to surrounding healthy cells—is impacted upon a neoplastic target 36 to damage, and ultimately destruct, the neoplastic target 36, and can form interference waves providing synergistic effect.

The neoplastic target 36 exhibits several resonant frequencies corresponding, for example, to distortion of the cell wall, distortion of the nucleus, etc. As with all objects, if the neoplastic target 36 is impacted with energy at a predetermined frequency, the portion of the input energy converted into mechanical energy, i.e. motion, will be significantly enhanced if the input frequency is at one of the resonant frequencies of the neoplastic target 36. See U.S. Pat. No. 4,315,514 to Drewes et al. (“Drewes”) at col. 1, lines 59-66. Drewes teaches how to determine resonant frequencies, and as such, is incorporated herein by reference thereto.

The neoplasm cell destruction 10 further comprises a feedback sensor 38. The feedback sensor 38 is in communication with the controller 16. The feedback sensor 38 receives feedback waves 40 emanating from the neoplastic target 36 when the neoplastic target 36 is impacted upon by the sound waves 34, and generates feedback signals 42 in response thereto, which is received by the controller 16, which in turn continually compares the feedback signals 42 to the sound waves 34 and automatically adjusts the at least one signal generator 12 accordingly until the sound waves 34 are at a resonant frequency of the neoplastic target 36 so as to maximize damage to the neoplastic target 36.

By utilizing the feedback sensor 38, one need not know in advance the resonant frequency to be used. The feedback sensor 38 receives the feedback waves 40 emanating from the neoplastic target 36 when the neoplastic target 36 is impacted upon by the sound waves 34, and generates the feedback signals 42 in response thereto, which is received by the controller 16, which in turn continually compares the feedback signals 42 to the sound waves 34 and automatically adjusts the at least one signal generator 12 accordingly until the sound waves 34 are at a resonant frequency of the neoplastic target 36.

It is to be understood that the controller 16 can be manually overridden. If so, the feedback signals 42 from the feedback sensor 38 would then go directly to the at least one signal generator 12, which would be manually adjusted accordingly until the sound waves 34 are at a resonant frequency of the neoplastic target 36 so as to maximize damage to the neoplastic target 36.

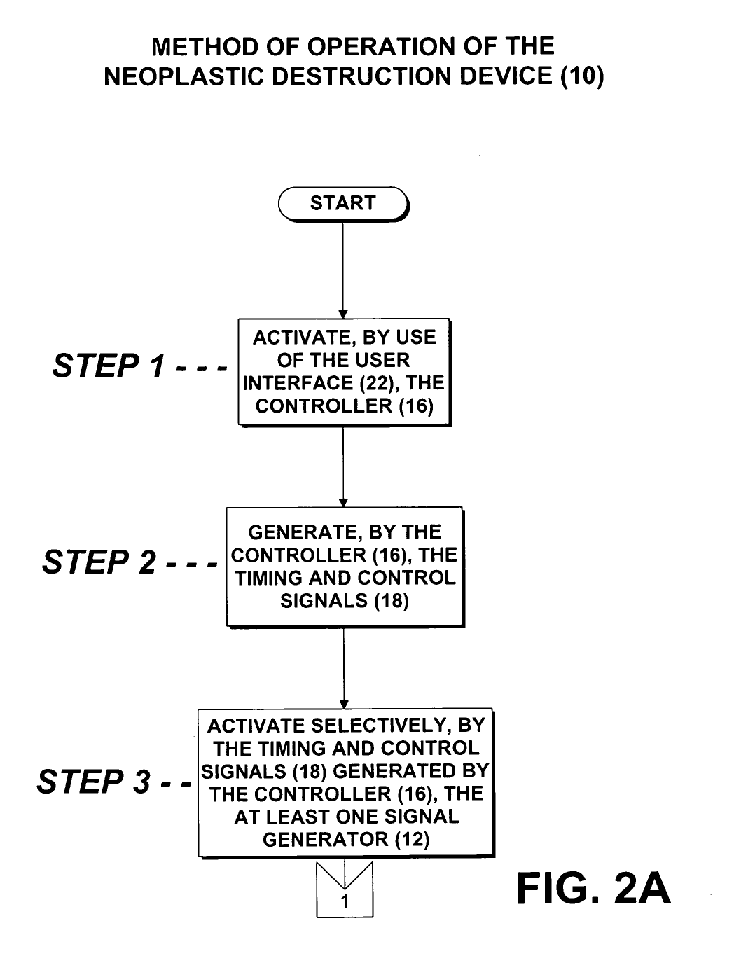

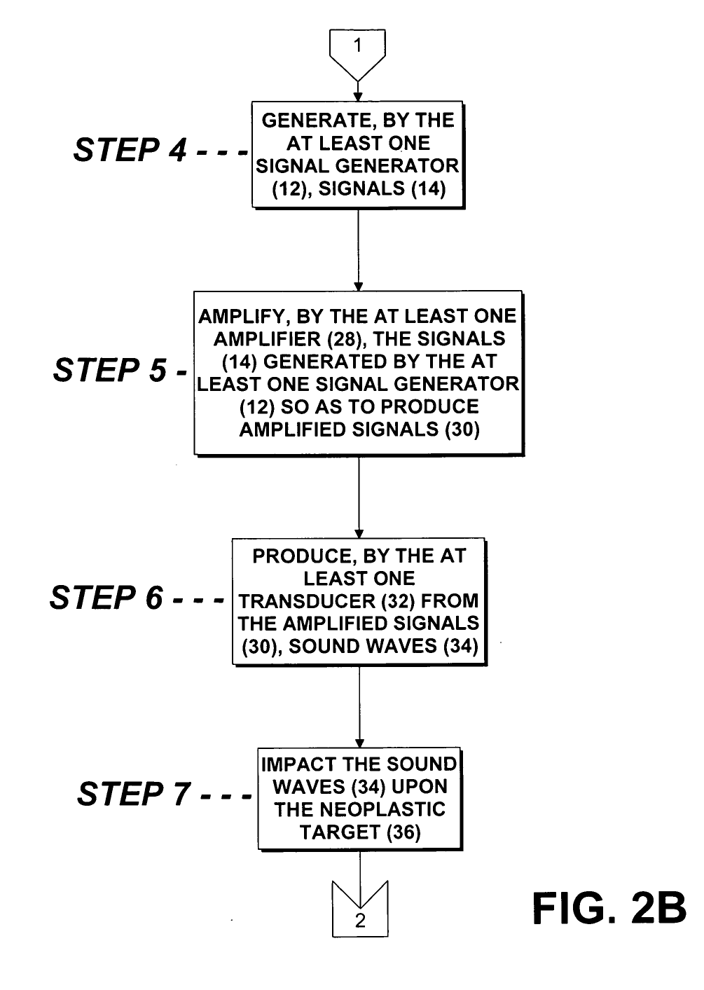

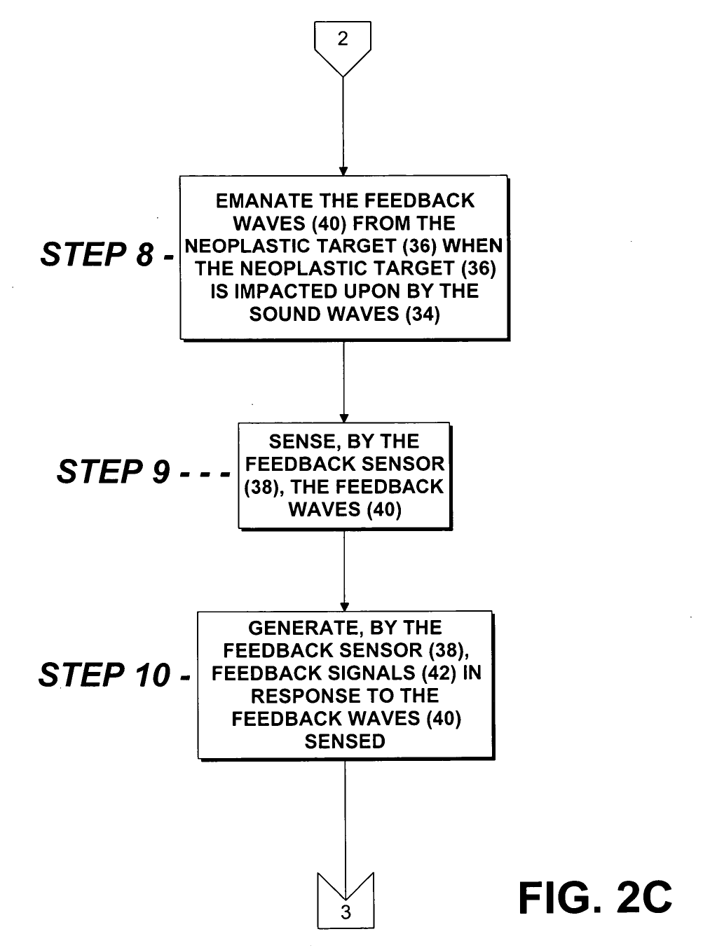

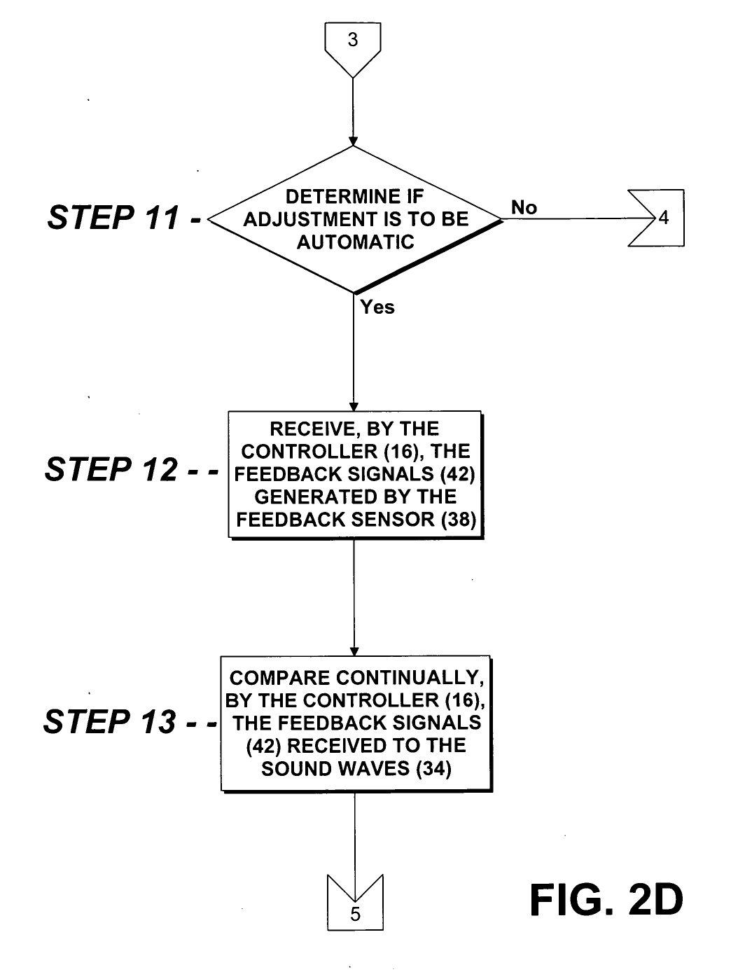

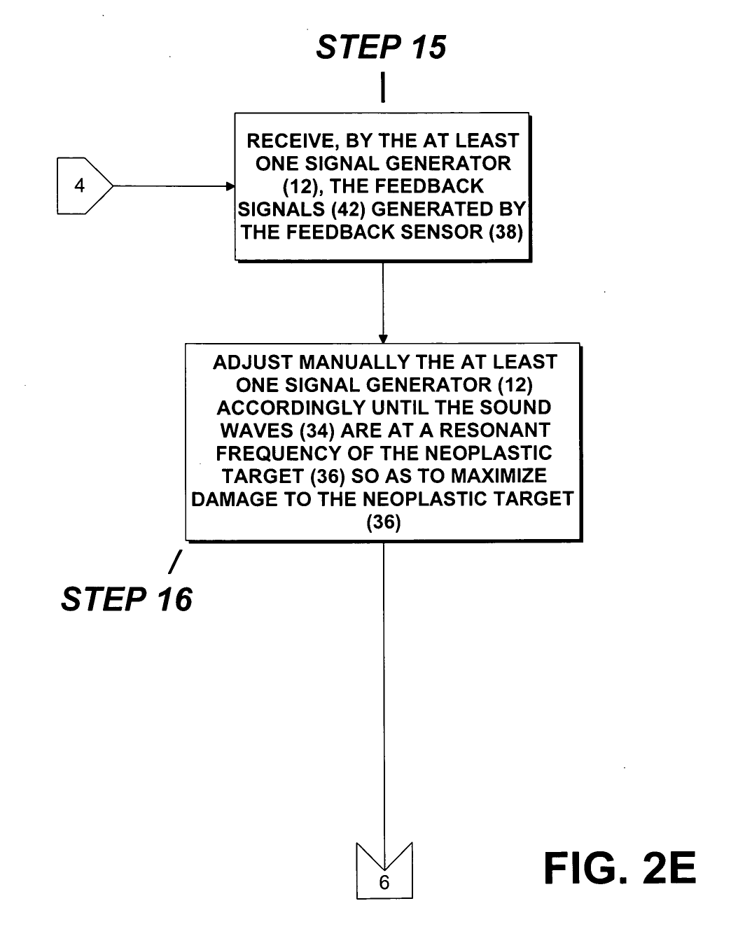

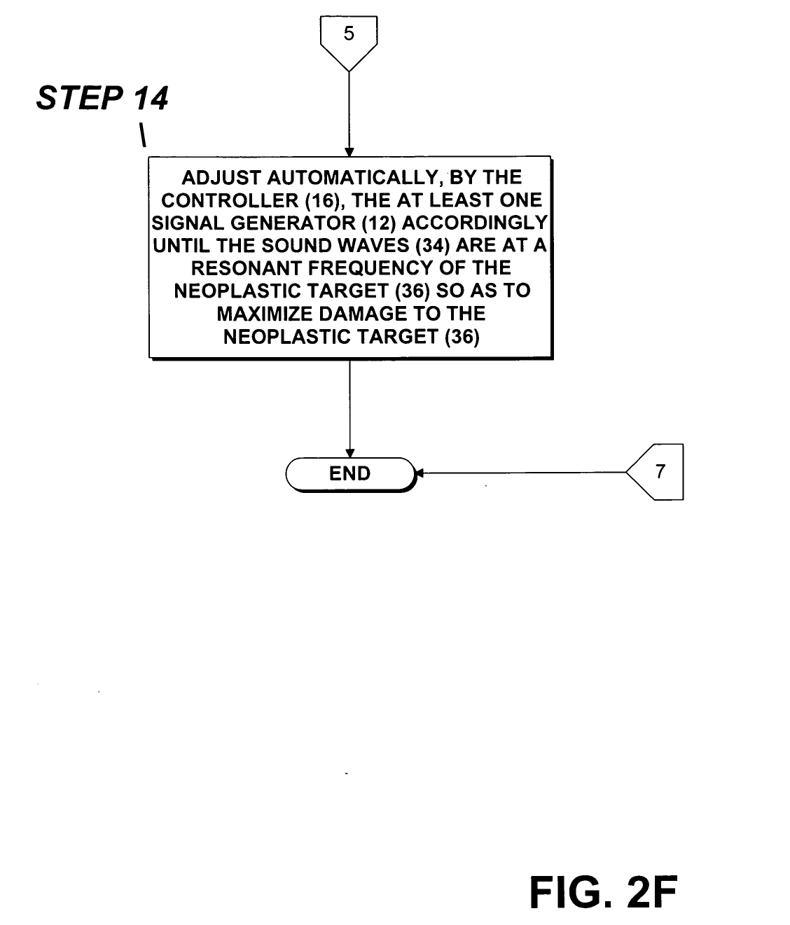

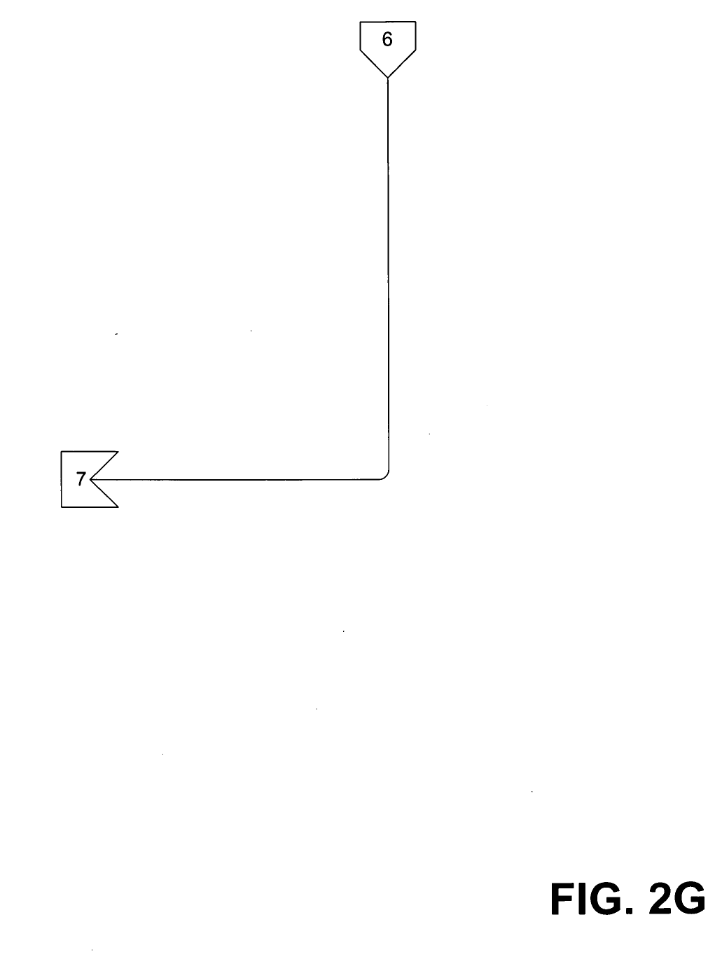

The method of operation of the neoplasm cell destruction device 10 can best be seen in FIGS. 2A to 2G, which is a flow chart of the method of operation of the present invention, and as such, will be discussed with reference thereto.
STEP 1: Activate, by use of the user interface 22, the controller 16.
STEP 2: Generate, by the controller 16, timing and control signals 18.
STEP 3: Activate selectively, by the timing and controls signals 18 generated by the controller 16, the at least one signal generator 12.
STEP 4: Generate, by the at least one signal generator 12, signals 14.
STEP 5: Amplify, by the at least one amplifier 28, the signals 14 generated by the at least one signal generator 12 to produce amplified signals 30.
STEP 6: Produce, by the at least one transducer 32 from the amplified signals 30, sound waves 34.
STEP 7: Impact the sound waves 34 upon the neoplastic target 36.
STEP 8: Emanate the feedback waves 40 from the neoplastic target 36 when the neoplastic target 36 is impacted upon by the sound waves 34.
STEP 9: Sense, by the feedback sensor 38, the feedback waves 40.
STEP 10: Generate, by the feedback sensor 38, a feedback signals 42 in response to the feedback waves 40 sensed.
STEP 11: Determine if adjustment is to be automatic.
STEP 12: Receive, by the controller 16, the feedback signals 42 generated by the feedback sensor 38, if answer to STEP 11 is yes.
STEP 13: Compare continually, by the controller 16, the feedback signals 42 received to the sound waves 34.
STEP 14: Adjust automatically, by the controller 16, the at least one signal generator 12 accordingly until the sound waves 34 are at a resonant frequency of the neoplastic target 36 so as to maximize damage to the neoplastic target 36.
STEP 15: Receive, by the at least one signal generator 12, the feedback signals 42 generated by the feedback sensor 38, if answer to STEP 11 is no.
STEP 16: Adjust manually the at least one signal generator 12 accordingly until the sound waves 34 are at a resonant frequency of the neoplastic target 36 so as to maximize damage to the neoplastic target 36.

It will be understood that each of the elements described above or two or more together may also find a useful application in other types differing from the types described above.

While the invention has been illustrated and described as embodied in a neoplasm cell destruction device, however, it is not limited to the details shown, since it will be understood that various omissions, modifications, substitutions, and changes in the forms and details of the device can be made by those skilled in the art without departing in any way from the spirit of the present invention.

Without further analysis the foregoing will so fully reveal the gist of the present invention that others can by applying current knowledge readily adapt it for various applications without omitting features that from the standpoint of prior art fairly constitute characteristics of the present invention.

1. A neoplasm cell destruction device, comprising:
a) at least one signal generator; and
b) at least one transducer;
wherein said at least one transducer is driven by said at least one signal generator;
wherein said at least one transducer produces sound waves; and
wherein said sound waves are impacted upon a neoplastic target to damage and ultimately destruct the neoplastic target.

2. The device as defined in claim 1, wherein said sound waves have frequencies in a range of 20-20,000 Hz.

3. The device as defined in claim 1, wherein said sound waves form interference waves providing synergistic effect.

4. The device as defined in claim 1, further comprising a controller;
wherein said controller is in communication with said at least one signal generator; and
wherein said controller generates timing and control signals to selectively activate said at least one signal generator.

5. The device as defined in claim 1, further comprising at least one amplifier;
wherein said at least one signal generator generates signals;
wherein said at least one amplifier amplifies said signals generated by said at least one signal generator so as to produce amplified signals; and
wherein said at least one transducer is driven by said amplified signals.

6. The device as defined in claim 4, wherein said controller is a microprocessor.

7. The device as defined in claim 4, further comprising a user interface; and
wherein said user interface is in communication with said controller.

8. The device as defined in claim 7, wherein said user interface is at least one of a keyboard and a display.

9. The device as defined in claim 5, further comprising a feedback sensor;
wherein said feedback sensor is in communication with said controller; and
wherein said feedback sensor receives feedback waves emanating from the neoplastic target when the neoplastic target is impacted upon by said sound waves and generates feedback signals in response thereto that are received by said controller that in turn continually compares the feedback signals received to said sound waves and automatically adjusts said at least one signal generator accordingly until said sound waves are at a resonant frequency of the neoplastic target so as to maximize damage to the neoplastic target.

10. The device as defined in claim 1, further comprising a feedback sensor;
wherein said feedback sensor is in communication with said at least one signal generator; and
wherein said feedback sensor receives feedback waves emanating from the neoplastic target when the neoplastic target is impacted upon by said sound waves and generates feedback signals in response thereto that are received by said at least one signal generator that in turn is manually adjusted accordingly until said sound waves are at a resonant frequency of the neoplastic target so as to maximize damage to the neoplastic target.

11. A method of damaging and ultimately destructing a neoplastic target, comprising the step of impacting the neoplastic target with sound waves emanating from a neoplasm cell destruction device, which comprises:
a) at least one signal generator; and
b) at least one transducer;
wherein said at least one transducer is driven by said at least one signal generator;
wherein said at least one transducer produces sound waves; and
wherein said sound waves are impacted upon a neoplastic target to damage and ultimately destruct the neoplastic target.

12. The method as defined in claim 11, wherein said sound waves have frequencies in a range of 20-20,000 Hz.

13. The method as defined in claim 11, wherein said sound waves form interference waves providing synergistic effect.

14. The method as defined in claim 11, further comprising a controller;
wherein said controller is in communication with said at least one signal generator; and
wherein said controller generates timing and control signals to selectively activate said at least one signal generator.

15. The method as defined in claim 11, further comprising at least one amplifier;
wherein said at least one signal generator generates signals;
wherein said at least one amplifier amplifies said signals generated by said at least one signal generator so as to produce amplified signals; and
wherein said at least one transducer is driven by said amplified signals.

16. The method as defined in claim 14, wherein said controller is a microprocessor.

17. The method as defined in claim 14, further comprising a user interface; and
wherein said user interface is in communication with said controller.

18. The method as defined in claim 17, wherein said user interface is at least one of a keyboard and a display.

19. The method as defined in claim 14, further comprising a feedback sensor;
wherein said feedback sensor is in communication with said controller; and
wherein said feedback sensor receives feedback waves emanating from the neoplastic target when the neoplastic target is impacted upon by said sound waves and generates feedback signals in response thereto that are received by said controller that in turn continually compares the feedback signals received to said sound waves and automatically adjusts said at least one signal generator accordingly until said sound waves are at a resonant frequency of the neoplastic target so as to maximize damage to the neoplastic target.

20. The method as defined in claim 11, further comprising a feedback sensor;
wherein said feedback sensor is in communication with said at least one signal generator; and
wherein said feedback sensor receives feedback waves emanating from the neoplastic target when the neoplastic target is impacted upon by said sound waves and generates feedback signals in response thereto that are received by said at least one signal generator that in turn is manually adjusted accordingly until said sound waves are at a resonant frequency of the neoplastic target so as to maximize damage to the neoplastic target.

21. A method of damaging and ultimately destructing a neoplastic target, comprising the step of impacting the neoplastic target with sound waves.

22. The method as defined in claim 21, wherein said step of impacting the neoplastic target with sound waves includes impacting the neoplastic target with sound waves having frequencies in a range of 20-20,000 Hz.

23. The method as defined in claim 21, wherein said step of impacting the neoplastic target with sound waves includes impacting the neoplastic target with sound waves that form interference waves providing synergistic effect.

24. A method of using a neoplasm cell destruction device to damage and ultimately destruct a neoplastic target, comprising the steps of:
a) driving, by at least one signal generator of the neoplasm cell destruction device, at least one transducer of the neoplasm cell destruction device;
b) producing, by the at least one transducer, sound waves;
c) impacting the sound waves upon a neoplastic target; and
d) damaging and ultimately destructing the neoplastic target.

25. The method as defined in claim 24, wherein said producing step includes producing the sound waves having frequencies in a range of 20-20,000 Hz.

26. The method as defined in claim 24, wherein said producing step includes producing the sound waves that form interference waves providing synergistic effect.

27. The method as defined in claim 24, further comprising the step of activating a controller of the neoplasm cell destruction device, which is in communication with the at least one signal generator, by use of a user interface of the neoplasm cell destruction device, which is in communication with the controller.

28. The method as defined in claim 27, further comprising the step of generating, by the controller, timing and control signals.

29. The method as defined in claim 28, further comprising the step of activating selectively the at least one signal generator by the timing and controls signals generated by the controller.

30. The method as defined in claim 24, further comprising the step of amplifying, by at least one amplifier of the neoplasm cell destruction device, which is in communication with the at least one signal generator, the signals generated by the at least one signal generator so as to produce amplified signals.

31. The method as defined in claim 30, wherein said producing step includes producing the sound waves from the amplified signals.

32. The method as defined in claim 24, further comprising the step of emanating feedback waves from the neoplastic target when the neoplastic target is impacted upon by the sound waves.

33. The method as defined in claim 32, further comprising the steps of:
a) sensing the feedback waves by a feedback sensor of the neoplasm cell destruction device, which is in communication with the controller;
b) generating feedback signals by the feedback sensor in response to the feedback waves sensed;
c) receiving the feedback signals by the controller;
d) comparing continually the feedback signals received by the controller to the sound waves; and
e) adjusting automatically the at least one signal generator accordingly until the sound waves are at a resonant frequency of the neoplastic target so as to maximize damage to the neoplastic target.

34. The method as defined in claim 32, further comprising the steps of:
a) sensing the feedback waves by a feedback sensor of the neoplasm cell destruction device, which is in communication with the at least one signal generator;
b) generating feedback signals by the feedback sensor in response to the feedback waves sensed;
c) receiving the feedback signals by the at least one signal generator; and
d) adjusting manually the at least one signal generator accordingly until the sound waves are at a resonant frequency of the neoplastic target so as to maximize damage to the neoplastic target.
